(19) United States
(12) Patent Application Publication
(10) Pub. No.: US 2003/0019960 A1
(43) Pub. Date: Jan. 30, 2003

(54) Metering valve

(76) Inventor: Hans-Christoph Magel, Pfullingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/111,692

(22) PCT Filed: Jul. 20, 2001
(86) PCT No.: PCT/DE01/02760

(30) Foreign Application Priority Data
Aug. 29, 2000 (DE) 10042309.4

(51) Int. Cl. B05B 1/30

(52) U.S. Cl. 239/585.5; 239/585.1; 239/88; 239/96; 239/533.9

(57) ABSTRACT

The invention relates to a metering valve for controlling the delivery of fuel from a high-pressure fuel line (1) to an injection nozzle (6) of an internal combustion engine, having one connection for the high-pressure fuel line (2), one connection for the injection nozzle (6), and one connection for a leak fuel line (13).

To improve the function and the quality of injection, in the metering valve two 2/2-way valves (3, 14), each with one control piston (15, 16), are combined with one another in such a way that the pressure forces operative on the control pistons (15, 16) in operation balance one another; one 2/2-way valve (3) has one connection for the injection nozzle (6) and one connection for the high-pressure fuel reservoir (1), and the other 2/2-way valve (14) has one connection for the injection nozzle (6) and one connection for the leak fuel (13).

### PRIOR ART

The invention relates to a metering valve for controlling the delivery of fuel from a high-pressure fuel line to an injection nozzle of an internal combustion engine, having one connection for the high-pressure fuel line, one connection for the injection nozzle, and one connection for a leak fuel line. Especially advantageously, the metering valve of the invention can be employed in common rail injection systems.

One such metering valve is known from German Patent Disclosure DE 197 24 637 A1, for instance. For introducing fuel into direct-injection Diesel engines, common rail injection systems are often used today. In common rail injection systems, a high-pressure pump pumps the fuel into a central high-pressure reservoir, known as a common rail. From the rail, high-pressure lines lead to the individual injection nozzles, which are assigned to the engine cylinders. By using one pump in common for all the cylinders, the injection pressure can be selected freely via a performance graph. To reduce emissions and to achieve high specific power levels, a high injection pressure is necessary. To achieve good exhaust gas values, some vehicle manufacturers prefer pressure-controlled injection. In conventional pressure-controlled common rail injection systems, 3/2-way valves are used for metering the fuel to the individual injection nozzles.

Known metering valves are not completely pressure-balanced. As a consequence, when high pressures are switched, there are major abrupt changes in force, which must be compensated for by a major actuator force and major spring forces. To make control with a small, high-speed actuator possible, a complicated hydraulic servo mechanism is necessary. A completely pressure-balanced design would necessitate a two-part valve housing. With a two-part valve housing, however, it is difficult to achieve an exact axial and parallel match of the valve seats for the sake of assuring closure of the valve seats in a manner secure against high pressure.

The object of the invention is to improve the function and quality of the injection. In particular, even at high injection pressures, a tight closure of the valve seats of the metering valve should be assured. Furthermore, the metering valve of the invention should be simple in construction and it should be possible to produce it economically.

This object is attained according to the invention by a metering valve, in particular for controlling the delivery of fuel from a high-pressure fuel line to an injection nozzle of an internal combustion engine, having one connection for the high-pressure fuel line, one connection for the injection nozzle, and one connection for a leak fuel line, wherein the metering valve, there are two valves, in particular two 2/2-way valves, each with a respective control piston; that the one valve has one connection for the injection nozzle and one connection for the high-pressure fuel line; that the other valve has one connection for the injection nozzle and one connection for the leak fuel line; and that the pressure forces operative during operation on the control piston balance one another.

Advantages of the Invention

The combination of the two 2/2-way valves offers the advantage that a completely pressure-balanced valve piston combination is created, which can be switched with little actuator force. As a result, the servo loop with inlet and outlet throttles that is required in conventional 3/2-way valves can be dispensed with. The two 2/2-way valves can be manufactured separately, and a result even at high pressures adequate tightness can be assured. It is even possible to use two identical 2/2-way valves, which reduces the production effort and expense considerably.

A particular embodiment of the invention is characterized in that the two 2/2-way valves are embodied in a two-part valve housing, in each case in the form of a seat valve with a control piston, which is guided so as to be capable of reciprocation on at least one side of the valve seat. The valve piston guide and the valve seat are each located in the same valve housing, which assures exact replicability in production. The embodiment as a seat valve offers the advantage that even at high pressures, adequate tightness can be assured. The guidance on both sides assures malfunction-free operation and a long service life of the metering valve of the invention.

A further particular embodiment of the invention is characterized in that the two control pistons are guided on a common axis, and their face ends facing one another contact one another. It is thus assured in a simple way that the pressure forces that occur during operation will be transmitted from one control piston to the other control piston.

A further particular embodiment of the invention is characterized in that a restoring spring is disposed on one of the face ends, facing away from one another, of the two control pistons, and an actuator is disposed on the other of the face ends, facing away from one another, of the two control pistons. This simple design makes the assembly of the metering valve of the invention easier in various ways.

A further particular embodiment of the invention is characterized in that the two control pistons communicate with one another via a hydraulic coupling chamber. This embodiment offers the advantage that the two control pistons need not be disposed on a common axis but instead can also be disposed at an angle to one another.

A further particular embodiment of the invention is characterized in that at least one of the control pistons is actuatable by means of an electromagnetic actuator or a piezoelectric actuator. Short switching times are thus made possible.

The object stated at the outset is also attained according to the invention by a fuel injection system for an internal combustion engine, having one high-pressure fuel line per cylinder, from which line fuel subjected to high pressure reaches an injection nozzle, through which the fuel is injected into the combustion chamber of an internal combustion engine, characterized in that one metering valve of the invention is disposed between each of the high-pressure fuel lines and the injection nozzles.

The above object is also attained, in a common rail injection system having a central high-pressure fuel reservoir, from which line fuel subjected to high pressure reaches an injection nozzle, through which the fuel is injected into the combustion chamber of an internal combustion engine, in that one metering valve as described above is disposed between each of the high-pressure fuel reservoir and the injection nozzles.

In a variant of a fuel injection system of the invention, a pressure booster is present between each of the metering valves and the injection nozzles, so that the injection pressure is increased and improved combustion is achieved.

Further advantages, characteristics and details of the invention will become apparent from the ensuing description, in which various exemplary embodiments of the invention are described in detail in conjunction with the drawing. The characteristics recited in the claims and mentioned in the description may each be essential to the invention alone or in arbitrary combination.

### DRAWING

Shown in the drawing are:

FIG. 1, a schematic illustration of a common rail injection system with a metering valve in accordance with a first embodiment of the present invention;

FIG. 2, a metering valve in a second embodiment of the invention; and

FIG. 3, a metering valve in a third embodiment of the invention.

### DESCRIPTION OF THE EXEMPLARY EMBODIMENTS

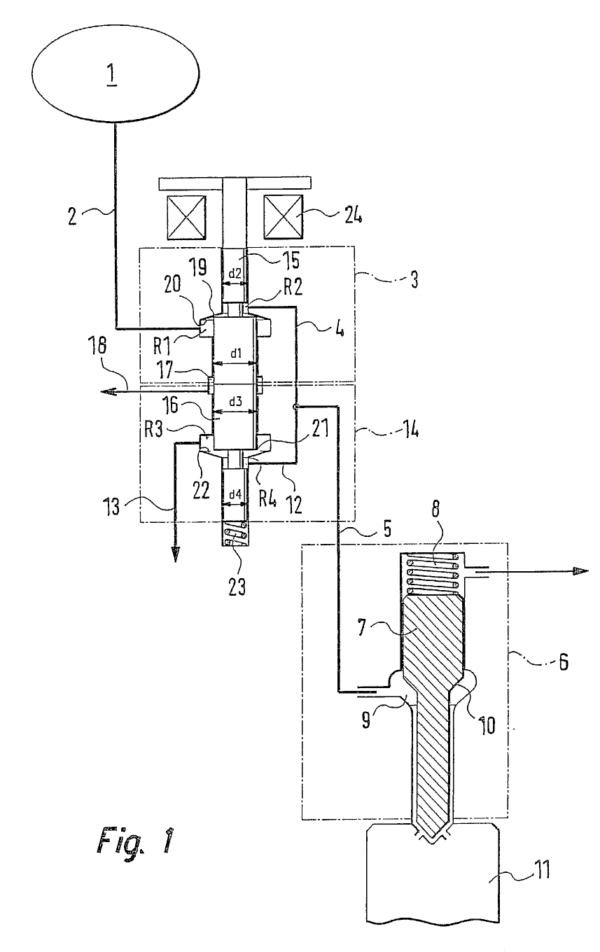

In FIG. 1, the central high-pressure fuel reservoir of a common rail injection system is marked 1. From the high-pressure fuel reservoir 1, a high-pressure fuel line 2 leads to a first 2/2-way valve 3. The 2/2-way valve 3 can be made to communicate with an injection nozzle 6 via a high-pressure fuel line 4 and a high-pressure fuel line 5.

In the injection nozzle 6, a nozzle needle 7 is received axially displaceably counter to the prestressing force of a nozzle spring 8. An encompassing pressure shoulder 10, which protrudes into an annular pressure chamber 9, is embodied on the nozzle needle 7. Depending on the valve position, the pressure chamber 9 is supplied with fuel via the high-pressure fuel line 5. If the pressure in the pressure chamber 9 suffices to overcome the prestressing force of the nozzle spring 8, the nozzle needle 7 lifts from its seat, and fuel is injected into a combustion chamber 11 of an internal combustion engine to be supplied.

In the valve position shown in FIG. 1, however, no injection takes place, since the pressure chamber 9 of the injection nozzle 6 communicates with a fuel return (not shown), via the high-pressure fuel line 5, a high-pressure fuel line 12, and a leak fuel line 13. The communication between the high-pressure fuel line 12 and the leak fuel line 13 is achieved via a second 2/2-way valve 14.

A first control piston 15 is received in a way capable of reciprocation in the first 2/2-way valve 3. A second control piston 16 is received in a way capable of reciprocation in the second 2/2-way valve 14. The two control pistons 15 and 16 are disposed in a two-part valve housing on one axis, in such a way that they rest with their face ends on one another in an annular chamber 17 formed by the two housing halves. Any leak fuel that may occur is removed from the annular chamber 17 via a leak fuel drain line 18.

The first control piston 15 has a first cylindrical portion, with a diameter d1, and a second cylindrical portion, with a diameter d2. The two cylindrical portions with the diameters d1 and d2 are joined to one another via an adapter. The diameter d1 is the largest. The diameter d2 is somewhat less than the diameter d1, and the diameter of the adapter is the smallest of the three. The second control piston 16 likewise includes two cylindrical portions, which are joined to one another via an adapter. One cylindrical portion has a diameter d3, which is equal to the diameter d1. The other cylindrical portion has a diameter d4, which is equal to the diameter d2.

A valve seat edge 19 with the diameter d1 is embodied on the first control piston 15. The valve seat edge 19 cooperates with a valve seat face 20 that is embodied on the valve housing. A valve seat edge 21 with the diameter d3 is embodied on the second control piston 16. The valve seat edge 21 cooperates with a valve seat face 22 that is embodied on the valve housing. The valve seat faces 20 and 22 are embodied in two different housing halves and can accordingly be machined separately.

The valve seat edge 19 and the valve seat face 20 together form a first valve seat. The valve seat edge 21 and the valve seat face 22 together form a second valve seat. The second control piston 16 is pressed with the aid of a restoring spring 23 against the first control piston 15 in such a way that the first valve seat 19, 20 is closed. When the first valve seat 19, 20 is closed, the communication between the high-pressure fuel reservoir 1 and the injection nozzle 6 is interrupted. Simultaneously the second valve seat 21, 22 is opened, so that the pressure chamber 9 is relieved via the lines 14, 12 and 13.

When an actuator 24 is actuated, the first control piston 15 and with the second control piston 16 are pressed downward, counter to the prestressing force of the restoring spring 23, in such a way that the valve seat edge 21 comes to rest on the valve seat edge 22. Accordingly, the second valve seat 21, 22 is closed, and the communication between the pressure chamber 9 of the injection nozzle 6 and the leak fuel line 13 is interrupted. Simultaneously, the first valve seat 19, 20 is opened. In this valve position, not shown in FIG. 1, the fuel subjected to high pressure passes out of the high-pressure fuel reservoir 1 via the high-pressure fuel line 2 and the high-pressure fuel line 5 to reach the pressure chamber 9 of the injection nozzle 6. Once the pressure is high enough the nozzle needle 7 lifts from its seat, and the injection ensues. The first 2/2-way valve 3, to which the rail is connected, is embodied in FIG. 1 as an inward-opening or so-called I-valve. The term “inward-opening” means that the control piston 15, upon opening of the first valve seat, is displaced counter to the fuel flow direction. Compared to outward-opening or A-valves, in which the opening direction of the valve member and the flow direction of the fuel engagement that ensues upon valve opening are in the same direction, the I-valves have the advantage of greater operating stability, since hydraulic pulse forces oriented counter to the fuel flow direction that occur in the opening process act to reinforce the opening, unlike the situation with the A-valve. In the switching position shown in FIG. 1, the first valve seat 19, 20 is closed, and the high-pressure chamber R1 is completely pressure-balanced. In the outflow chamber R2, the first 2/2-way valve 3 necessarily has a pressure face of area A2=π/4× (d²-d2²), since for producing the valve seat, a diameter reduction from d1 to d2 is necessary. Once the first valve seat 19, 20 is opened, the control piston 15 is imparted a pressure force of the pressure in the chamber R2 onto the face of area A2.

The second 2/2-way valve 14 likewise has a pressure-balanced chamber R3. In the chamber R4, there is now once again a pressure face of area A4=π/4× (d3² -d4²), which results from the diameter reduction from d3 to d4. Since the chamber R2 communicates with the chamber R4, the same pressure level prevails in both chambers. If the pressure face areas A2 and A4 are equal, then the complete valve combination is completely pressure-balanced. This makes an actuation with little actuator force possible, by means of a magnetic actuator or a piezoelectric actuator. By varying the area of a pressure face, either an opening or a closing hydraulic supplementary force can be generated, which can be utilized for targeted optimization of the switching behavior.

Since the valve chamber R3 is likewise pressure-balanced, a counterpressure in the leak fuel line 13 does not affect the switching function of the metering valve.

The fuel diverted via the leak fuel line 13 at the end of injection can therefore also be used for a hydraulically reinforced closure of the nozzle needle 7. To that end, a dammed-up counterpressure can be generated, which via a pressure face on the nozzle needle 7 exerts a closing force on the nozzle needle 7.

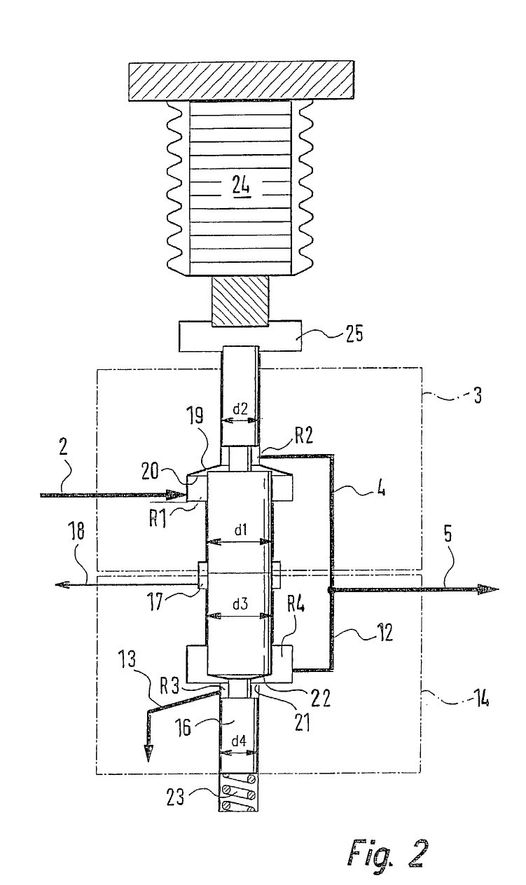

The metering valve shown in FIG. 2 is similar to the metering valve shown in FIG. 1. For the sake of simplicity, the same reference numerals will therefore be used to identify identical parts. Moreover, to avoid repetition, reference is made to the above description of FIG. 1, and only the differences between the two embodiments will be addressed below.

In the embodiment shown in FIG. 2, the actuation of the metering valve is effected not via a magnetic actuator but rather via a piezoelectric actuator 24 and a coupling chamber 25. The sealing seat 21/22 in this embodiment is embodied with the diameter d4. Since in this exemplary embodiment the line 12 into the chamber 4, the metering unit is once again completely pressure-balanced.

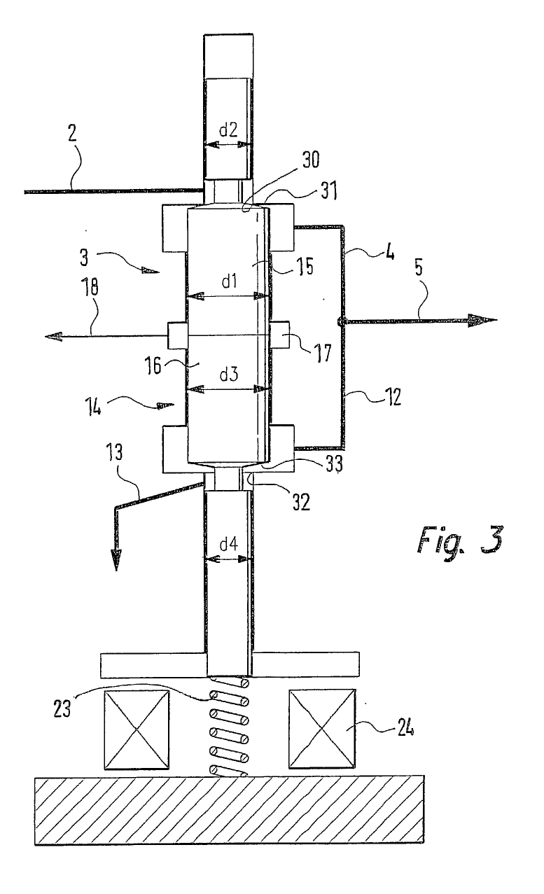

The embodiment of a metering valve of the invention shown in FIG. 3 is extensively equivalent to the embodiment shown in FIG. 1. To avoid repetition, only the differences between the two embodiments will be addressed below.

In the embodiment shown in FIG. 3, the first valve 3 is embodied as an A-valve, rather than as an I-valve as in FIG. 1. On the valve housing, a valve seat edge 30 with the diameter d2 is embodied, which cooperates with a valve seat face 31 embodied on the control piston 15. A valve seat edge 32 with the diameter d4 is also embodied on the valve housing and cooperates with a valve seat face 33 embodied on the control piston 16. Otherwise, the metering valve shown in FIG. 3 functions like the metering valve shown in FIG. 1 and is also actuated via a magnetic actuator 24. The actuator 24 and the spring 23 are disposed on the same side of the valve piston.

All the characteristics described in the description, recited in the following claims and shown in the drawing can be essential to the invention both individually or in arbitrary combination with one another.

1. A metering valve, in particular for controlling the delivery of fuel from a high-pressure fuel line (2) to an injection nozzle (6) of an internal combustion engine, having one connection for the high-pressure fuel line (2), one connection for the injection nozzle (6), and one connection for a leak fuel line (13), characterized in that in the metering valve, there are two valves, in particular two 2/2-way valves (3, 14), each with a respective control piston (15, 16); that the one valve (3) has one connection for the injection nozzle (6) and one connection for the high-pressure fuel line (2); that the other valve (14) has one connection for the injection nozzle (6) and one connection for the leak fuel line (13); and that the pressure forces operative during operation on the control piston (15, 16) balance one another.

2. The metering valve of claim 1, characterized in that the high-pressure fuel line (2) communicates with a central high-pressure fuel reservoir (1).

3. The metering valve of claim 1 or 2, characterized in that the two 2/2-way valves (3, 14) are embodied in a two-part valve housing, in each case in the form of a seat valve with a control piston (15, 16), which is guided so as to be capable of reciprocation on at least one side of the valve seat.

4. The metering valve of claim 3, characterized in that the two control pistons (15, 16) are guided on a common axis, and their face ends facing one another contact one another.

5. The metering valve of claim 3 or 4, characterized in that a restoring spring (23) is disposed on one of the face ends, facing away from one another, of the two control pistons (15, 16), and an actuator (24) is disposed on the other of the face ends, facing away from one another, of the two control pistons (15, 16).

6. The metering valve of one of claims 3-5, characterized in that the two control pistons (15, 16) communicate with one another via a hydraulic coupling chamber.

7. The metering valve of one of the foregoing claims, characterized in that at least one of the control pistons (15, 16) is actuatable by means of an electromagnetic actuator or a piezoelectric actuator.

8. A fuel injection system for an internal combustion engine, having one high-pressure fuel line (2) per cylinder, from which line fuel subjected to high pressure reaches an injection nozzle (6), through which the fuel is injected into the combustion chamber of an internal combustion engine, characterized in that one metering valve of one of the foregoing claims is disposed between each of the high-pressure fuel lines (2) and the injection nozzles (6).

9. A fuel injection system having a central high-pressure fuel reservoir (1), from which line fuel subjected to high pressure reaches an injection nozzle (6), through which the fuel is injected into the combustion chamber of an internal combustion engine, characterized in that one metering valve of one of the foregoing claims is disposed between each of the high-pressure fuel reservoir (1) and the injection nozzles (6).

10. The fuel injection system of claim 8 or 9, characterized in that a pressure booster is present between each of the metering valves and the injection nozzles (6).
